(19) United States
(12) Patent Application Publication
(10) Pub. No.: US 2017/0270327 A1
(43) Pub. Date: Sep. 21, 2017

(54) READING OF RADIO FREQUENCY IDENTIFICATION TAG

(71) Applicant: GUANGZHOU BIO-MATCH TECH LTD., Guangzhou City (CN)

(72) Inventors: Qibi Liang, Guangzhou City (CN); Yi Ouyang, Guangzhou City (CN); Ke Zeng, Guangzhou City (CN)

(21) Appl. No.: 15/435,135

(22) Filed: Feb. 16, 2017

(30) Foreign Application Priority Data
Mar. 15, 2016 (CN) 201610146999.X

(51) Int. Cl. G06K 7/10; G06K 19/077

(52) U.S. Cl. CPC G06K 7/10366; G06K 19/0772

(57) ABSTRACT

The application discloses a radio frequency identification (RFID) tag reading system, an RFID reading-writing apparatus and an RFID tag reading method. According to an embodiment of the RFID tag reading system, an RFID tag is attached to a side surface of a sample vessel and stores preset information indicating a unique identity of one or more biological samples loaded in the sample vessel. When an RFID reading-writing apparatus and the sample vessel are arranged on a same bench, and a distance between the RFID reading-writing apparatus and the RFID tag is less than or equal to a preset induction distance, the RFID reading-writing apparatus can read the preset information stored in the RFID tag through an induction field which is generated on a side of the RFID reading-writing apparatus and can emit radio frequency signals along a substantially horizontal direction.

### CROSS REFERENCE TO RELATED APPLICATIONS

The present application claims priority to Chinese Patent Application No. 201610146999.X, filed on Mar. 15, 2016, the entire contents of which are hereby incorporated by reference for all purposes.

### TECHNICAL FIELD

The present disclosure relates to the technical field of medical treatment, and particularly relates to a Radio Frequency Identification (RFID) tag reading system, an RFID reading-writing apparatus and an RFID tag reading method.

### BACKGROUND

A Human Assisted Reproductive Technology (ART) refers to a technology for making an infertile couple to pregnant by using medical assisted means, including Artificial Insemination (AI), In-vitro fertilization and Embryo Transfer (IVF-ET) and derivative technologies thereof. For example, a test-tube baby is conceived by using AFIVF-ET technology.

Various operational processes in the IVF-ET technology (hereinafter also referred to as IVF), including the in-vitro fertilization for sperm and oocyte, embryo transfer, embryo freezing, embryo thawing and so on, may be inspected by double manual checks based on identity information of concerned sperms, oocytes and embryos, so as to ensure the concerned sperms, oocytes and embryos correspond to a couple and avoid occurrence of identity mismatch.

### SUMMARY

The present disclosure provides an RFID tag reading system, an RFID reading-writing apparatus and an RFID tag reading method, by which problems arising from attaching an RFID tag to a bottom of a vessel may be avoided.

According to a first aspect of the present disclosure, an RFID tag reading system is provided, and the RFID tag reading system comprises a sample vessel, an RFID reading-writing apparatus and an RFID tag. Where, the sample vessel is configured to load at least one biological sample. In general, there is a plurality of biological samples in the sample vessel. The RFID reading-writing apparatus is configured to generate an induction field on a side of the apparatus, and the induction field may emit a radio frequency signal along a substantially horizontal direction. The RFID tag is attached to a side surface of the sample vessel, and configured to store preset information indicating a unique identity of the biological sample. The RFID tag may implement space coupling with the RFID reading-writing apparatus via the radio frequency signal.

According to a second aspect of the present disclosure, an RFID reading-writing apparatus is provided, and the RFID reading-writing apparatus comprises an induction-field-generating module and an information-reading module. Where, the induction-field-generating module is configured to generate an induction field on a side of the RFID reading-writing apparatus, and the induction field may emit a radio frequency signal along a substantially horizontal direction. The information-reading module is configured to read preset information stored in an RFID tag through the induction field when the RFID reading-writing apparatus and a sample vessel attached with the RFID tag are horizontally arranged and the distance between the information-reading module and the RFID tag attached to a side surface of the sample vessel is less than or equal to a preset induction distance. The RFID tag can implement space coupling with the RFID reading-writing apparatus via the radio frequency signal.

According to a third aspect of the present disclosure, an RFID tag reading method is provided, and the RFID tag reading method comprises the following steps: attaching an RFID tag to a side surface of a sample vessel, where the sample vessel is configured to load at least one biological sample, and the RFID tag is configured to store preset information indicating a unique identity of the biological sample loaded in the sample vessel; arranging the sample vessel and an RFID reading-writing apparatus on a same bench surface, where the RFID reading-writing apparatus is configured to generate an induction field on a side thereof and the induction field may emit a radio frequency signal along a substantially horizontal direction; and reading the preset information stored in the RFID tag by the RFID reading-writing apparatus through the induction field when the distance between the RFID reading-writing apparatus and the RFID tag is less than or equal to a preset induction distance.

By attaching the RFID tag to a side surface of the sample vessel, when the RFID reading-writing apparatus and the sample vessel are horizontally arranged and the distance between the RFID tag and the RFID reading-writing apparatus is less than or equal to the preset induction distance, the preset information stored in the RFID tag attached on the side surface of the sample vessel may be read through an induction field. Where, the induction field is generated on the side of the RFID reading-writing apparatus and capable of emitting a radio frequency signal along a substantially horizontal direction. In this way, because the RFID tag is not required to be attached to a bottom of the sample vessel, problems such as decreasing actual use area of a culture dish, limiting observation perspective and so on which arise from attaching the RFID tag to the bottom of the sample vessel may be effectively avoided. Further, because the RFID tag is attached to the side surface of the sample vessel, the preset information stored in the RFID tag may be read through the induction field generated on the side of the RFID reading-writing apparatus without any signal interference due to a metal bench, and thus a constant-temperature system integrated in the metal bench, i.e., an existing resource of the user may be fully used.

### BRIEF DESCRIPTION OF DRAWINGS

To illustrate the technical solutions of the embodiments of the present disclosure more clearly, the accompanying drawings required to describe the embodiments are briefly introduced below. Apparently, the accompanying drawings in the following descriptions show only some exemplary embodiments of the present disclosure, and a person skilled in the art may still derive other drawings from the accompanying drawings without creative efforts. The present disclosure will be further described below with reference to the following accompanying drawings, where:

FIG. 1 is a structural schematic diagram of an RFID tag reading system according to an embodiment of the present disclosure;

FIG. 2 is a structural schematic diagram of an RFID reading-writing apparatus according to an embodiment of the present disclosure;

FIG. 3 is a flow diagram of an RFID tag reading method according to an embodiment of the present disclosure;

FIG. 4 is a schematic diagram of an application scenario of the RFID tag reading system according to an embodiment of the present disclosure.

### DETAILED DESCRIPTION

The technical solutions of the embodiments of the present disclosure will be described clearly and completely below with combination of the accompanying drawings in the embodiments of the present disclosure. It is obvious that the described embodiments are only a part rather than all of the embodiments of the present disclosure. All other embodiments obtained by a person skilled in the art based on the embodiments of the present disclosure without creative efforts shall fall within the protection scope of the present disclosure.

Words and terms shall be understood based on the context, for example, the term ‘if’ used herein may be interpreted as ‘under the condition of . . . ’, ‘when . . . ’ or ‘in response to a determination that’.

For ensuring infallibility of information match in a process of assisted reproduction operation, an IVF check system may be adopted. The IVF check system may implement match confirmation for information of related IVF operation by reading the information stored in an RFID tag on a culture dish with an RFID reading-writing apparatus. Where, biological samples such as sperms, oocytes, embryos and so on required by an IVF operation may be loaded in the culture dish. If it is found that the biological samples in a pre-set RFID area do not belong to a same couple, the IVF check system will output an alarm. RFID is a communication technology for identifying a specific objective by reading and/or writing related data through radio frequency signals without establishing a mechanical or optical contact between an identification system and the specific objective. For example, an RFID tag may be attached to the bottom of a culture dish. In this case, when the culture dish is placed on a horizontal surface of a reading-writing apparatus in a way that the reading-writing apparatus contacts the bottom of the culture dish, the reading-writing apparatus may read information in the RFID tag for checking. However, because the RFID tag is attached to the bottom of the culture dish, when the biological samples loaded in the culture dish are observed through a microscope, an area to which the RFID tag is attached may produce a shadow and affects the observation view of the microscope. However, if the biological samples are placed out of the area to which the RFID tag is attached, the usable area of the culture dish will be significantly decreased.

In addition, for IVF operation, the biological samples in the culture dish are required to be at a temperature which is close to a typical human body temperature such as 36.5 ° C. In fact, many IVF clinics have already purchased expensive IVF workstations with constant temperature bench surface made of metal or containing metal materials. When a culture dish is placed on a metal-containing bench surface, the interference of metal to radio frequency signals may be so strong that an RFID tag attached to the bottom of the culture dish may not be correctly read by an RFID reading-writing apparatus. Therefore, some manufacturers provide a RFID reading-writing apparatus in which a constant temperature module is directly integrated so as to ensure that a culture dish placed on the surface of the RFID reading-writing apparatus is in a constant temperature environment. In this way, the clinics cannot directly use an already purchased IVF workstation in which a constant temperature system is integrated, thereby causing waste of resources.

The present disclosure provides an RFID tag reading system, by which problems arising from attaching an RFID tag to bottom of a sample vessel can be avoided.

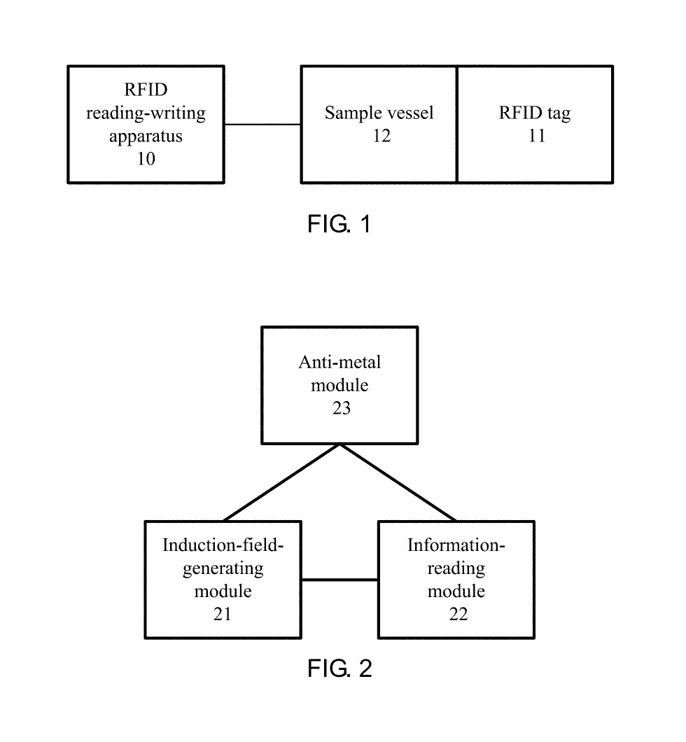

FIG. 1 is a structural schematic diagram of an RFID tag reading system according to an embodiment of the present disclosure. As shown in FIG. 1, the RFID tag reading system comprises an RFID reading-writing apparatus 10, an RFID tag 11 and a sample vessel 12. Where, the RFID tag 11 is attached to a side surface of the sample vessel 12, and the RFID reading-writing apparatus 10 and the sample vessel 12 may be, for example, horizontally and adjacently arranged on a same bench. The RFID tag 11 is configured to store preset information and may implement space coupling with the RFID reading-writing apparatus 10 via radio frequency signals. The sample vessel 12 may be used as a carrier attached with the RFID tag 11.

When the distance between the RFID reading-writing apparatus 10 and the RFID tag 11 attached to the side surface of the sample vessel 12 is less than or equal to a preset induction distance, the RFID reading-writing apparatus 10 can read the preset information stored in the RFID tag 11 through an induction field which is generated on the side of the RFID reading-writing apparatus 10 and capable of emitting radio frequency signals substantially along the horizontal direction. For example, the space (non-contact) coupling via radio frequency signals can be implemented between the RFID tag 11 and the RFID reading-writing apparatus 10 through a coupling element. In a coupling channel, transfer of energy, exchange of data and the like can be implemented according to a time-sequence relation.

FIG. 4 is a schematic diagram of an application scenario of the RFID tag reading system according to an embodiment of the present disclosure. FIG. 4 shows a position relation among the RFID reading-writing apparatus 10, the RFID tag 11 and the sample vessel 12. Where, a middle concave part of the RFID reading-writing apparatus 10 faces right against a pillar 40 of a microscope to inspect the sample vessel 12.

The RFID tag mainly comprises an RFID chip and metal lines, i.e., an RFID tag antenna around the RFID chip. The size of an RFID tag is mainly determined by the size of the RFID tag antenna. In general, the larger the size of the RFID tag antenna is, the farther the induction distance of the RFID tag is, and the more stable the reading performance of the RFID tag is. For meeting requirements of induction distance and stability for common commercial scenarios, RFID tag antennas currently sold in market are normally 7 mm or bigger in size and the widths of commercial RFID tags are all more than 10 mm. The heights of vessels for IVF operation, however, are normally around 10 mm. As a result, if an RFID tag with a width equal to or more than 10 mm is attached to a side surface of a sample vessel with a height about 10 mm, the vessel cannot be covered properly, nor be used in normal way. Therefore, for ensuring that an RFID tag can be attached to a side surface of a sample vessel for IVF operation without affecting the use of the sample vessel, and reaching an induction distance required for IVF operation, various RFID tag antennas of different specifications, shapes and materials are fabricated with different processes and tested by the inventor, and RFID tag antennas of about 5 mm in width were produced finally. After integrating with synthetic materials and an RFID chip, an RFID tag product of 7 mm in width and 16 mm in length has been developed. Although the induction distance of the RFID tag is slightly smaller than the induction distance of a current commercially-available conventional RFID tag of 10 mm wide or wider, the induction distance of the RFID tag is enough to meet the requirements of IVF operation. Meanwhile, because the width of the RFID tag is smaller than the height of a sample vessel, and the length of the RFID tag is moderate, the RFID tag can be easily attached to an arc side surface of most of sample vessels without affecting IVF operation. For example, under the condition that the sample vessel 12 is a culture dish with a height greater than or equal to 10 mm, the RFID tag 11 may be a circular RFID tag with a diameter less than or equal to 7 mm, or a square RFID tag with a height less than or equal to 7 mm.

In addition, for IVF operation, besides a sample vessel with a height of 10 mm or more, other sample vessel with a height less than 10 mm may be also occasionally used, such as the height of 8 mm. For a sample vessel with a height less than 10 mm, the height of an attachable area on a side surface of the sample vessel may be only about 5 mm. Therefore, for attaching an RFID tag to the side surface of such kind of lower sample vessel, the inventor also developed an RFID tag of about 5 mm in height and 30 mm in length through repeated testing, and the RFID tag can be attached to the side surface of a sample vessel of almost the lowest height for IVF operation. The induction distance of the 5 mm wide RFID tag is smaller than the induction distance of the 7 mm wide RFID tag, but still can meet the requirement for IVF operation.

It should be pointed out that the RFID tag 11 can not only be a tag from which information can be read and in which information can be written, but also be a tag from which information can be read but in which information cannot be written. The specific details above are not limited by the present disclosure so long as information in the RFID tag 11 can be read.

Moreover, the numerals here are just for illustration, and the present disclosure should not be confined to this. For example, if the height of the sample vessel 12 is 10 mm, the diameter or height of the RFID tag 11 may be less than or equal to 10 mm, for instance, the RFID tag may be a rectangular tag of 16 mm in length and 7 mm in height; for another example, if the sample vessel 12 is a culture dish with a diameter of 35 mm and a height of about 10 mm, the diameter or height of the RFID tag 11 is preferably less than or equal to 10 mm, for instance, the RFID tag may be a circular tag with a diameter of 10 mm.

Where, the induction distance can be less than or equal to 6 cm. The induction distance is dependent mainly on an induction field. Where, the induction field is generated on a side of the reading-writing apparatus 10 and may emit radio frequency signals substantially along the horizontal direction. For example, the induction distance may be less than or equal to 6 cm, 8 cm, 10 cm or more. With the RFID reading-writing apparatus production technology developing, the induction distance will increase. In addition, an induction field can be generated and concentrated on a side of the RFID reading-writing apparatus 10 by controlling an angle and direction of the induction field of the RFID reading-writing apparatus 10, which may be more conducive to reading the RFID tag 11 attached to the side surface of the sample vessel 12.

Where, the RFID reading-writing apparatus 10 may be a high-frequency RFID reading-writing apparatus, and the RFID tag 11 may be a high-frequency RFID tag. The high-frequency RFID reading-writing apparatus 10 may be a high-frequency RFID antenna.

Where, the preset information in the RFID tag 11 may not only include an ID number such as a global unique ID, but also include data pre-stored in an EEPROM integrated in the tag.

Where, the RFID reading-writing apparatus 10 may be formed in a concave shape as shown in FIG. 4. The middle concave part of the RFID reading-writing apparatus 10 may face against a pillar 40 of a microscope. The height of the RFID reading-writing apparatus 10 may be about 10 mm, but not limited to this. The length and width of the RFID reading-writing apparatus 10 may be changed according to the size of a user's bench, for example, the minimum width can be 1.5 cm, and the minimum length can be 10 cm. The shape and height of the RFID reading-writing apparatus 10 may be changed, as long as radio frequency signals emitted from the side of the RFID reading-writing apparatus 10 are basically parallel to the bench surface and can be inducted by the RFID tag 11 attached to the side surface of the sample vessel 12.

Where, the sample vessel 12 may be loaded with at least one biological sample such as sperm, oocyte, embryo and the like for IVF operation. Preset information indicating a unique identity of the biological sample can be stored in the RFID tag 11.

Where, the RFID reading-writing apparatus 10 may have been anti-metal processed, so that the RFID reading-writing apparatus 10 can be placed on a metal or non-metal bench in which a constant temperature system is integrated. This anti-metal processing can be implemented by any known anti-metal processing technology. For example, the surface of the RFID reading-writing apparatus 10 may be processed, or the surface of the RFID reading-writing apparatus 10 may be made with a preset material, and the like. Because the RFID reading-writing apparatus 10 have been anti-metal processed, the reading performance of the RFID tag 11 will not be affected even the RFID reading and writing apparatus 10 is working on a surface of a metal bench.

FIG. 2 is a structural schematic diagram of an RFID reading-writing apparatus according to an embodiment of the present disclosure. As shown in FIG. 2, the RFID tag reading-writing apparatus may comprise an induction-field-generating module 21 and an information-reading module 22.

Where, the induction-field-generating module 21 may be configured to generate an induction field on a side of the RFID reading-writing apparatus and the induction field is capable of emitting radio frequency signal along a substantially horizontal direction. The information-reading module 22 may be configured to read preset information stored in the RFID tag attached to a side surface of the sample vessel through the induction field generated by the induction-field-generating module 21 when the distance between the information-reading module 22 and the RFID tag attached to the side surface of the sample vessel is less than or equal to a preset induction distance. Where, the RFID tag and the RFID reading-writing apparatus implement space coupling via the radio frequency signals.

In general, an RFID reading-writing apparatus in the market is large in volume and may take up a larger space when placed on an IVF operation bench, which will affect operations of embryologists. In order to avoid this, the inventor makes an overall volume of the RFID reading-writing apparatus much smaller by customizing smaller electronic components, configuring a smaller induction-field-generating module and a smaller information-reading module and the like. Meanwhile, the inventor also changed the shape of the RFID reading-writing apparatus according to arrangement of objects on the IVF operation bench in a way that the RFID reading-writing apparatus can be placed on an area in which there is nothing placed usually. Therefore, an operation area of the bench normally used by embryologists may not be affected. For example, as shown in FIG. 4, the RFID reading-writing apparatus 10 can be designed as a substantial rectangle shape with a middle concave, and the middle concave part may face right against a pillar 40 of a microscope on the IVF operation bench.

Moreover, radio frequency signals generated on a side of a conventional RFID reading-writing apparatus and emitted along a substantially horizontal direction are usually poor in stability and easily interfered by a metal bench, thereby affecting the induction distance and the induction stability. For this reason, the inventor ensures that radio frequency signals emitted from the induction-field-generating module can be stably kept in a direction along a horizontal bench surface by adjusting multiple parameters, and thus the RFID reading-writing apparatus can relatively stably read the information in the RFID tag attached to a side surface of the sample vessel.

As shown in FIG. 2, for minimizing influence of the metal bench on the stability of radio frequency signals emitted from the RFID reading-writing apparatus, the RFID reading-writing apparatus may also include an anti-metal module 23. Because most of IVF operation bench surfaces are made of metal materials, the anti-metal module 23 can be configured to carry out anti-metal processing on the RFID reading-writing apparatus, so that even if the RFID reading-writing apparatus works on a surface of a metal bench, the reading performance thereof on the RFID tag is not affected. Therefore, the RFID reading-writing apparatus can be used on a metal or non-metal bench.

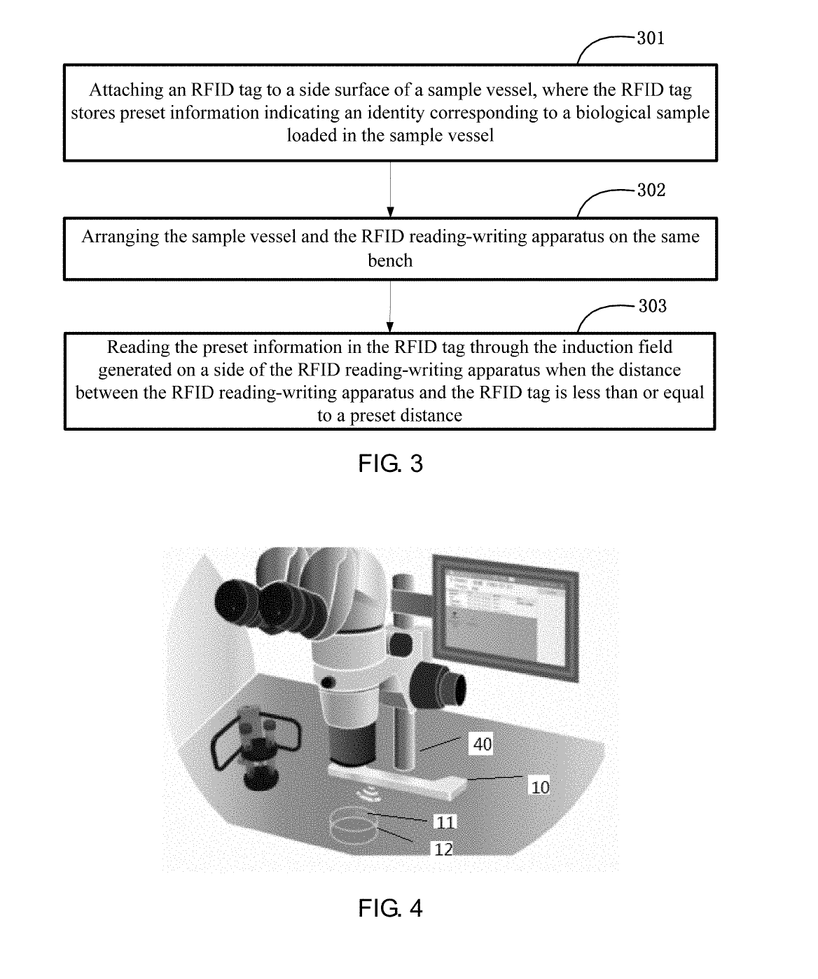

FIG. 3 is a flow diagram of an RFID tag reading method according to an embodiment of the present disclosure. As shown in FIG. 3, the tag reading method comprises the following steps.

In step 301, an RFID tag may be attached to a side surface of a sample vessel. Where the RFID tag may store preset information, and the preset information may indicate an identity corresponding to at least one biological sample loaded in the sample vessel. Further, the RFID tag and the RFID reading-writing apparatus may implement space coupling via radio frequency signals.

According to an embodiment, a circular RFID tag with a diameter less than or equal to the height of the sample vessel, or a square RFID tag with a width (also called ‘height’) less than or equal to the height of the sample vessel may be selected and attached to a side surface of the sample vessel.

Where, the RFID reading-writing apparatus may be a high-frequency RFID reading-writing apparatus, and the RFID tag may be a high-frequency RFID tag. In addition, the induction distance may be less than or equal to 6 cm, 8 cm, 10 cm or more. The induction distance may increase as related technology develops.

Where, the sample vessel may be loaded with at least one biological sample, and the biological sample may include sperm, oocyte, embryo and the like for IVF process. Preset information indicating a unique identity of the biological sample loaded in the sample vessel may be stored in the RFID tag.

In step 302, the sample vessel and an RFID reading-writing apparatus may be arranged on a same bench. Where an induction field capable of emitting radio frequency signals along a substantially horizontal direction may be generated on a side of the RFID reading-writing apparatus.

According to an embodiment, the RFID reading-writing apparatus and the sample vessel may be placed on a metal or non-metal bench in which a constant-temperature system is integrated.

In step 303, when the distance between the RFID reading-writing apparatus and the RFID tag attached to a side surface of the sample vessel is less than or equal to a preset induction distance, the preset information in the RFID tag may be read through the induction field generated on the side of the RFID reading-writing apparatus.

By attaching the RFID tag to a side surface of the sample vessel, when the distance between the RFID reading-writing apparatus and the RFID tag attached to the side surface of the sample vessel is less than or equal to the preset induction distance, the preset information stored in the RFID tag attached to the side surface of the sample vessel can be read through an induction field generated on a side of the RFID reading-writing apparatus. In this way, because the RFID tag is not required to be attached to the bottom of the sample vessel, problems such as decreasing actual use area of the sample vessel and affecting observation view can be effectively avoided. Meanwhile, because the RFID tag is attached to the side surface of the sample vessel, the preset information stored in the RFID tag can be read through the induction field generated on the side of the RFID reading-writing apparatus, so that signal interference caused by a metal bench can be avoided. In this way, the RFID reading-writing apparatus and the sample vessel of which a side surface is attached with an RFID tag can be directly placed on a metal or non-metal bench in which a constant temperature system is integrated, without integrating the constant-temperature module in the RFID reading-writing apparatus.

Details of the implementation processes of functions and roles of each unit in the apparatus above are already disclosed in the implementation processes of corresponding steps of the method, and not provided herein.

Because the embodiments of the device are basically corresponding to the embodiments of the method, for relevant mentions, please see part of descriptions of the embodiments of the method. The described embodiments of the device are only schematic, units described as separate parts therein may be or not be physically separated, and components displayed as units may be or not be physical units, i.e., the components may be located in one place, or distributed on multiple network units. Part or all of the modules may be selected to achieve the purpose of the solutions of the present disclosure according to actual needs. A person skilled in the art can understand and implement the solutions of the present disclosure without additional creative efforts.

The technical solutions provided in the embodiments of the present disclosure are introduced in detail. In this text, a specific case is applied for expounding the principle and mode of execution of the present disclosure, and the explanation on the embodiments above are just adopted for helping understand the method of the present disclosure and the key points. Meanwhile, persons of ordinary skill in the art, based on the thought of the present disclosure, can change the actual mode of execution and application range of the present disclosure. To sum up, the content of the specification should not be interpreted as limitation to the present disclosure.

1. A radio frequency identification (RFID) tag reading system, comprising:
a sample vessel configured to load at least one biological sample;
an RFID reading-writing apparatus configured to generate an induction field on a side of the RFID reading-writing apparatus, wherein, the induction field is capable of emitting radio frequency signals along a substantially horizontal direction; and
an RFID tag attached to a side surface of the sample vessel and configured to store preset information indicating a unique identity of the biological sample, wherein, the RFID tag is capable of implementing space coupling with the RFID reading-writing apparatus via the radio frequency signals.

2. The RFID tag reading system according to claim 1, wherein:
when the RFID reading-writing apparatus and the sample vessel are arranged on a same bench, and the distance between the RFID tag and the RFID reading-writing apparatus is less than or equal to a preset induction distance, the RFID reading-writing apparatus reads the preset information stored in the RFID tag through the induction field.

3. The RFID tag reading system according to claim 1, wherein:
the RFID tag is a circular RFID tag; and
a diameter of the circular RFID tag is less than or equal to a height of the sample vessel.

4. The RFID tag reading system according to claim 1, wherein:
the RFID tag is a square RFID tag; and
a width of the square RFID tag is less than or equal to a height of the sample vessel.

5. The RFID tag reading system according to claim 1, wherein:
the sample vessel is a culture dish with a diameter greater than or equal to 35 mm and a height greater than or equal to 8 mm; and
a height of the RFID tag is less than or equal to 7 mm.

6. The RFID tag reading system according to claim 1, wherein:
the biological sample includes at least one of sperm, oocyte and embryo for In-vitro fertilization (IVF); and
the preset information stored in the RFID tag indicates a unique identity of the biological sample.

7. The RFID tag reading system according to claim 1, wherein:
the RFID reading-writing apparatus has been subjected to anti-metal processing; and
the RFID reading-writing apparatus is placed on a metal bench in which a constant-temperature system is integrated.

8. A radio frequency identification (RFID) reading-writing apparatus, comprising:
an induction-field-generating module for generating an induction field on a side of the RFID reading-writing apparatus, wherein the induction field is capable of emitting radio frequency signals along a substantially horizontal direction; and
an information-reading module for reading preset information stored in an RFID tag through the induction field when the RFID reading-writing apparatus and a sample vessel are arranged on a same bench and the distance between the information-reading module and the RFID tag attached to a side surface of the sample vessel is less than or equal to a preset induction distance, wherein the RFID tag can implement space coupling with the RFID reading-writing apparatus via the radio frequency signals.

9. The RFID reading-writing apparatus according to claim 8, further comprises:
an anti-metal module for carrying out anti-metal processing on the RFID reading-writing apparatus.

10. The RFID reading-writing apparatus according to claim 8, wherein the RFID reading-writing apparatus is of a substantially rectangular shape with a middle concave part.

11. A radio frequency identification (RFID) tag reading method, comprising:
attaching an RFID tag to a side surface of a sample vessel, wherein the sample vessel is to load at least one biological sample, and the RFID tag is to store preset information indicating a unique identity of the biological sample loaded in the sample vessel;
arranging the sample vessel and an RFID reading-writing apparatus on a same bench, wherein the RFID reading-writing apparatus is to generate an induction field on a side of the RFID reading-writing apparatus, and the induction field is capable of emitting radio frequency signals along a substantially horizontal direction; and
reading the preset information stored in the RFID tag through the induction field by the RFID reading-writing apparatus when the distance between the RFID reading-writing apparatus and the RFID tag is less than or equal to a preset induction distance.

12. The RFID tag reading method according to claim 11, wherein attaching the RFID tag to the side surface of the sample vessel comprises:
selecting a circular RFID tag with a diameter less than or equal to a height of the sample vessel; and
attaching the selected circular RFID tag to the side surface of the sample vessel.

13. The RFID tag reading method according to claim 11, wherein attaching the RFID tag to the side surface of the sample vessel comprises:
selecting a square RFID tag with a width less than or equal to the height of the sample vessel; and
attaching the selected square RFID tag to the side surface of the sample vessel.

14. The RFID tag reading method according to claim 11, wherein:
the biological sample includes at least one of sperm, oocyte and embryo for In-vitro fertilization (IVF); and
the preset information stored in the RFID tag indicates a unique identity of the biological sample.
